(19) United States
(12) Patent Application Publication
(10) Pub. No.: US 2025/0252630 A1
(43) Pub. Date: Aug. 7, 2025

(54) INFORMATION PROCESSING APPARATUS CAPABLE OF GENERATING LAYOUT IMAGE INCLUDING TEXT ASSOCIATED WITH SELECTED IMAGE, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: MASARU ONO, Ibaraki (JP)

(21) Appl. No.: 19/033,738

(22) Filed: Jan. 22, 2025

(30) Foreign Application Priority Data
Feb. 2, 2024 (JP) 2024-014878

(51) Int. Cl. G06T 11/60; G06V 40/16; G10L 15/26

(52) U.S. Cl. CPC G06T 11/60; G06V 40/172; G10L 15/26

(57) ABSTRACT

An information processing apparatus capable of selecting a desired image, and generating a layout image including the selected image and text associated therewith. A network controller acquires image data including an image of a person, and audio data associated with the image data, and an audio data conversion section converts the acquired audio data to text data. The image data is selected on an operation screen, and a layout image generation section generates a layout image in which are arranged specific text data of voice uttered by the person included in the selected image data, in the text data, and the selected image data.

### BACKGROUND OF THE INVENTION

### Field of the Invention

The present invention relates to an information processing apparatus capable of generating a layout image including text associated with a selected image, a method of controlling the information processing apparatus, and a storage medium.

### Description of the Related Art

Conventionally, as a technique for recognizing audio data of recorded person conversation and changing the audio data into text, there has been known an audio recognition technique. Japanese Laid-Open Patent Publication (Kokai) No. 2019-149083 describes a meeting minutes generation apparatus that changes audio data of voice generated during a meeting into text by the audio recognition technique and then generates summary text by summarizing the contents of the audio data of the meeting. The meeting minutes generation apparatus disclosed in Japanese Laid-Open Patent Publication (Kokai) No. 2019-149083 is capable of generating a layout by associating summary text and image data used during the meeting. The layout plays the role of leaving a record of the meeting. Further, there has been proposed a shooting apparatus that stores personal information, such as face photos, in advance. The shooting apparatus is capable of tracking a person as an object based on the personal information and shooting a photo or a moving image of the person at a desired timing. To shoot a private scene, such as a state of bearing children, for example, by using such a shooting apparatus, it is conceivable that a layout is generated by combining image data recorded by the shooting apparatus and audio data, but this is different from the case of generation of a layout of a meeting. Specifically, in the case of the meeting, as a general rule, it is preferable to generate a layout from the start of a meeting until the end of the same, but in the case of private scenes, it is preferable to select a scene which looks relatively good in a photo and is desired to be left as a memory, and generate a layout of the scene.

However, in Japanese Laid-Open Patent Publication (Kokai) No. 2019-149083, there is a problem that it is difficult to select a desired scene to be left as a memory to thereby generate a layout of the scene.

### SUMMARY OF THE INVENTION

The invention provides an information processing apparatus capable of selecting a desired image, and generating a layout image including the selected image and text associated therewith, a method of controlling the information processing apparatus, and a storage medium.

In a first aspect of the invention, there is provided an information processing apparatus including at least one memory and at least one processor which function as: an acquisition unit configured to acquire image data including an image of a person, and audio data associated with the image data, a conversion unit configured to convert the audio data acquired by the acquisition unit to text data, a selection unit configured to select the image data acquired by the acquisition unit, and a generation unit configured to generate a layout image in which are arranged specific text data of voice uttered by the person included in the image data selected by the selection unit, in the text data, and the image data selected by the selection unit.

In a second aspect of the invention, there is provided a method of controlling an information processing apparatus, including acquiring image data including an image of a person, and audio data associated with the image data, converting the audio data acquired by the acquiring to text data, selecting the image data acquired by the acquiring, and generating a layout image in which are arranged specific text data of voice uttered by the person included in the image data selected by the selecting, in the text data, and the image data selected by the selecting.

According to the invention, it is possible to select a desired image, and thereby acquire a layout image including the selected image and text associated therewith.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a layout image generation system.

FIG. 2 is a block diagram showing a hardware configuration of a shooting apparatus.

FIG. 3 is a block diagram showing a software configuration of the shooting apparatus.

FIG. 4 is a block diagram showing a hardware configuration of an information processing apparatus.

FIG. 5 is a block diagram showing a software configuration of the information processing apparatus.

FIG. 6 is a block diagram showing a hardware configuration of a printing apparatus.

FIG. 7 is a block diagram showing a software configuration of the printing apparatus.

FIG. 8 is a flowchart of a process performed by the shooting apparatus.

FIG. 9 is a view showing an example of personal information stored in the shooting apparatus.

FIG. 10A is a flowchart of a process performed by the information processing apparatus.

FIG. 10B is an image diagram illustrating an example of processing performed by the information processing apparatus.

FIG. 11 is a flowchart of a process performed by the printing apparatus.

FIGS. 12A and 12B are diagrams each showing an example of a layout image.

FIG. 13 is a flowchart of a text conversion process as a subroutine performed in a step of the process shown in FIG. 10A.

FIG. 14 is a diagram showing an example of text information.

FIG. 15 is a flowchart of a face extraction process as a subroutine performed in a step of the process shown in FIG. 10A.

FIGS. 16A to 16C are diagrams each showing an example of face area information.

FIG. 17 is a flowchart of a layout image generation process as a subroutine performed in a step of the process shown in FIG. 10A.

FIGS. 18A-A to 18A-D are diagrams showing an example of operation screens on which operations are performed during generating of the layout image.

FIGS. 18B-A to 18B-C are diagrams showing a variation of operation screens on which operations are performed during generating of the layout image.

### DESCRIPTION OF THE EMBODIMENTS

The present invention will now be described in detail below with reference to the accompanying drawings showing embodiments thereof. However, the configuration described in the following embodiments is given only by way of example, and is by no means intended to limit the scope of the present invention. For example, the components forming the present invention each can be replaced by a desired component which can exhibit the same function. Further, a desired component can be added.

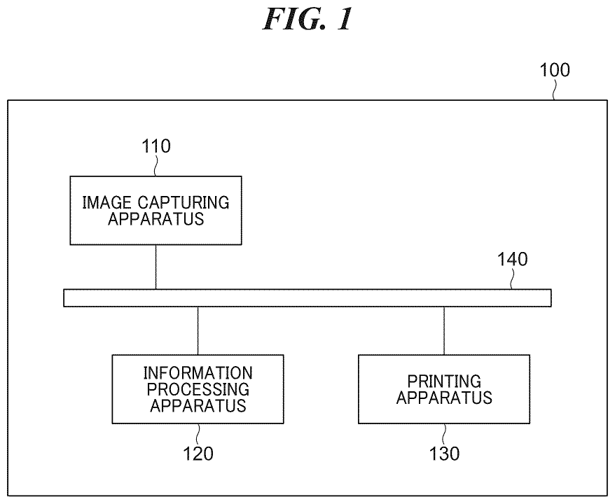

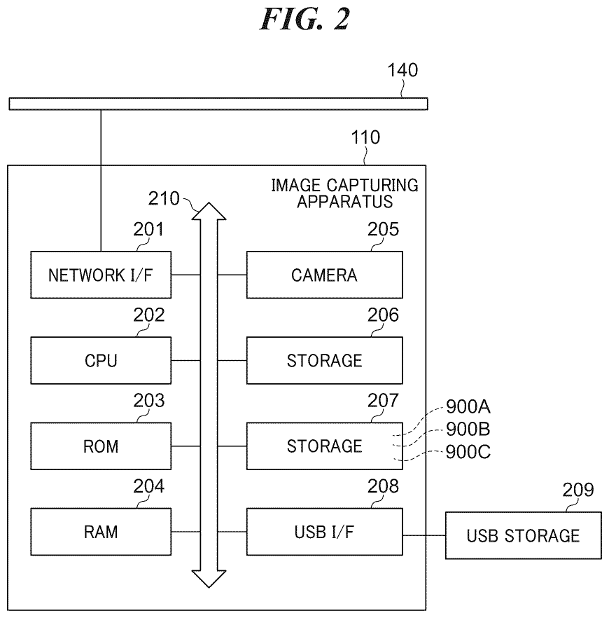

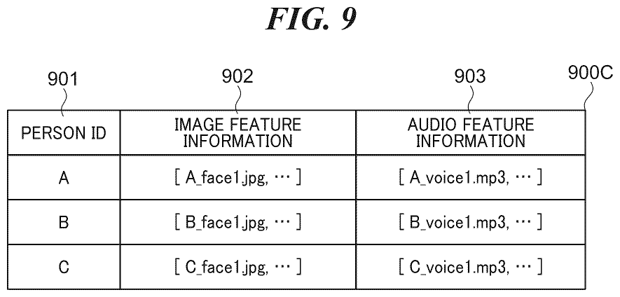

FIG. 1 is a block diagram showing a hardware configuration of a layout image generation system. As shown in FIG. 1, the layout image generation system, denoted by reference numeral 100, includes a shooting apparatus (image capturing apparatus) 110, an information processing apparatus 120, and a printing apparatus 130, and these are communicably connected to each other via a network 140. The network 140 is e.g. a Wide Area Network (WAN) or a Local Area Network (LAN). Note that communication connection is not limited to connection via the network 140, but for example, Bluetooth communication or USB wired connection can be used. In the present embodiment, the shooting apparatus 110 is a digital video camera capable of shooting a moving image. This shooting apparatus 110 is used for capturing an image of a person as an object. With this, image data (moving image data) 900A including an image of a person is acquired. The image data 900A is data formed by a plurality of frames. Note that the number of persons included in the image data 900A can be one or a plurality depending on the cases. Further, in the case of moving image shooting, the shooting apparatus 110 also acquires audio data 900B collectively associated with the plurality of frames forming the image data 900A. The audio data 900B mainly includes real voice of a person. Note that the real voice of a person, included in the audio data 900B, can be real voice of one person or can be real voices of a plurality of persons. Further, the shooting apparatus 110 also acquires personal information (person identification data) 900C for identifying the person included in the image data 900A. The image data 900A, the audio data 900B, and the personal information 900C are stored in a storage 207 of the shooting apparatus 110 (see FIG. 2). The shooting apparatus 110 is configured to be capable of automatically controlling panning and tilting and is used in a state placed e.g. on a table or rack in a house. In this placed state, the shooting apparatus 110 is capable of automatically detecting and tracking a face of a person existing in the house based on the personal information 900C. The personal information 900C will be described hereinafter with reference to FIG. 9. The shooting apparatus 110 can transmit the image data 900A, the audio data 900B, and the personal information 900C to the information processing apparatus 120 via the network 140. With this, the information processing apparatus 120 can receive and acquire the image data 900A, the audio data 900B, and the personal information 900C.

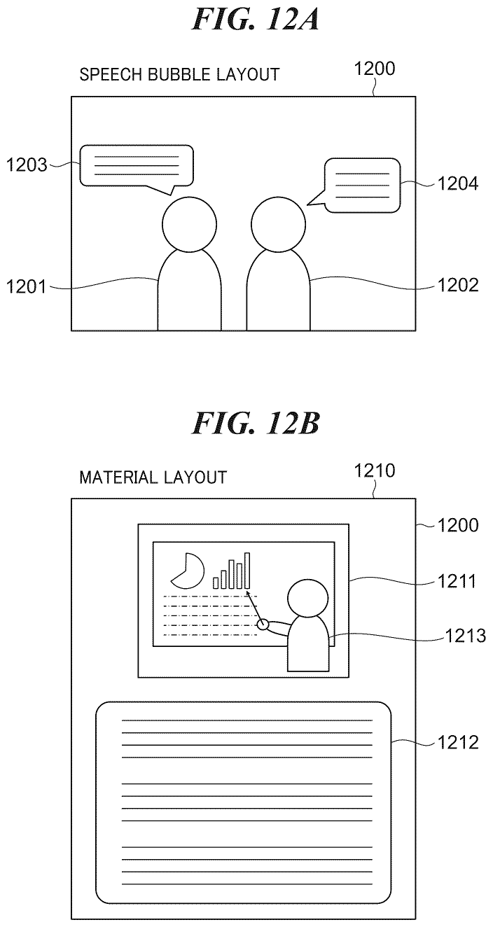

The information processing apparatus 120 is, for example, a desktop-type or laptop-type personal computer, a tablet terminal, or a smartphone. Note that the information processing apparatus 120 can have a function as a cloud server. The information processing apparatus 120 is capable of generating a layout image 1200 (see FIG. 12A) and a layout image 1210 (see FIG. 12B). The layout image 1200 and the layout image 1210 each are an image in which the image data 900A and text data converted from the audio data 900B by using the audio recognition technique are arranged. These images are stored in a USB storage 411 of the information processing apparatus 120 and transmitted to the printing apparatus 130 via the network 140. Then, in a case where the layout image 1200 or the layout image 1210 is received, the printing apparatus 130 can print each received image. The printing apparatus 130 is an apparatus that forms an image, characters, and so forth e.g. on a print sheet with toner or ink. The printing apparatus 130 is not particularly limited, but for example, a Multi Function Printer (MFP), a Single Function Printer (SFP), or the like can be used. In a case where a print job (print instruction) is received from the information processing apparatus 120, the printing apparatus 130 analyzes data included in the print job and executes image processing for printing. After execution of the image processing, the printing apparatus 130 performs printing with respect to e.g. a print sheet.

FIG. 2 is a block diagram showing a hardware configuration of the shooting apparatus. As shown in FIG. 2, the shooting apparatus 110 includes a network Interface (I/F) 201, a central processing unit (CPU) 202, a read only memory (ROM) 203, a random access memory (RAM) 204, a camera 205, a microphone 206, the storage 207, and a USB I/F 208. The network I/F 201 to the USB I/F 208 are connected in a state communicable with each other, i.e. in a state in which data can be transmitted and received to and from each other via a system bus 210. The network I/F 201 transmits and receives a variety of data to and from an external apparatus, such as the information processing apparatus 120, via the network 140. The CPU 202 is a controller (computer) for controlling the overall operation of the shooting apparatus 110. The CPU 202 starts an operating system (OS) according to a boot program stored in the ROM 203 which is a nonvolatile memory. Further, the CPU 202 can control the overall operation of the shooting apparatus 110 by executing control programs stored in the storage 207, on the OS. These control programs include, for example, a program for causing the CPU 202 to execute a method of controlling the components and means of the shooting apparatus 110. The RAM 204 operates as a temporary storage area, such as a main memory and a work area for the CPU 202. The storage 207 is a nonvolatile writable and readable memory, such as an HDD or an SSD, and can store not only the above-mentioned control programs, but also the image data 900A and the audio data 900B, for example.

The camera 205 is capable of shooting a moving image and a still image. With this, the image data 900A can be obtained. To the image data 900A, EXIF information, such as shooting date and time and a shooting location, is attached. The microphone 206 can convert voice input via this microphone 206 to digital signals. With this, the audio data 900B can be obtained. To the audio data 900B, the EXIF information, such as shooting date and time and a shooting location, is attached. In the case of moving image shooting, the image data 900A and the audio data 900B are associated with each other based on the EXIF information. The USB I/F 208 is an interface which can be connected to a USB storage 209 via serial communication. With this, it is also possible to store the image data 900A and the audio data 900B in the USB storage 209. Further, the shooting apparatus 110 can also be connected to an external apparatus, such as the information processing apparatus 120, via the USB I/F 208.

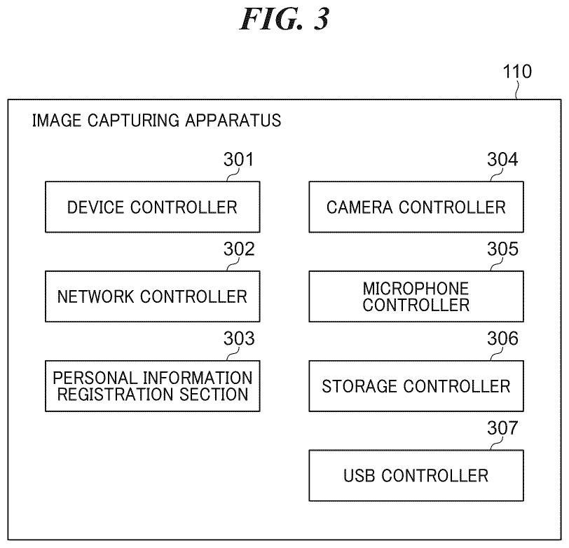

FIG. 3 is a block diagram showing a software configuration of the shooting apparatus. As shown in FIG. 3, the shooting apparatus 110 includes a device controller 301, a network controller 302, a personal information registration section 303, a camera controller 304, a microphone controller 305, a storage controller 306, and a USB controller 307. These software functions are realized by the CPU 202 that executes programs loaded in the RAM 204. The device controller 301 has a function of controlling the components from the network controller 302 to the USB controller 307. With this, the overall operation of the shooting apparatus 110 is controlled. The network controller 302 has a function of transmitting and receiving a variety of data to and from an external apparatus by communicating with the network 140 via the network I/F 201. With this, the shooting apparatus 110 can transmit, for example, the image data 900A, the audio data 900B, and the personal information 900C to the information processing apparatus 120. The personal information registration section 303 has a function of registering the personal information 900C which is feature information for identifying a person based on face image data included in the image data 900A and the audio data 900B. As described above, the shooting apparatus 110 is capable of automatically detecting and tracking a face of a person based on the personal information 900C. The camera controller 304 has a function of controlling the camera 205 to perform shooting by using this camera 205. The microphone controller 305 has a function of controlling the microphone 206 to collect sound via this microphone 206. The storage controller 306 has a function of controlling the storage 207 to write and read a variety of data into and from the storage 207. The USB controller 307 has a function of controlling an external device and the USB storage 209, which are connected via the USB I/F 208.

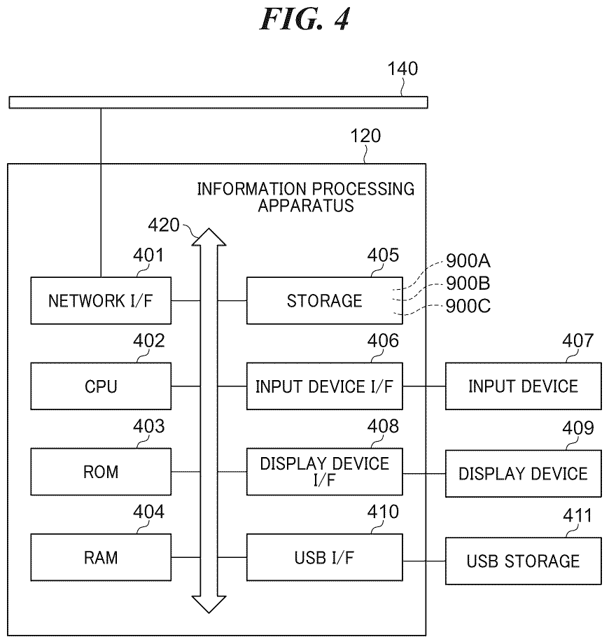

FIG. 4 is a block diagram showing a hardware configuration of the information processing apparatus. As shown in FIG. 4, the information processing apparatus 120 includes a network I/F 401, a CPU 402, a ROM 403, a RAM 404, a storage 405, an input device I/F 406, an input device 407, a display device I/F 408, and a USB I/F 410. The network I/F 401 to the USB I/F 410 are connected in a state communicable with each other via a system bus 420. The network I/F 401 transmits and receives a variety of data to and from an external apparatus, such as the shooting apparatus 110 and the printing apparatus 130, via the network 140. The CPU 402 is a controller (computer) for controlling the overall operation of the information processing apparatus 120. The CPU 402 starts an OS according to a boot program stored in the ROM 403 as a nonvolatile memory. Further, the CPU 402 can control the overall operation of the information processing apparatus 120 by executing control programs stored in the storage 405, on the OS. These control programs include, for example, a program for causing the CPU 402 to execute a method of controlling the components and means of the information processing apparatus 120 (method of controlling the information processing apparatus). The RAM 404 operates as a temporary storage area, such as a main memory and a work area for the CPU 402. The storage 405 is a nonvolatile writable and readable memory, such as an HDD or SSD, and can store not only the above-mentioned control programs, but also the image data 900A and the audio data 900B, which are transmitted from the shooting apparatus 110, for example.

The input device I/F 406 is an interface which can be connected to the input device (operation unit) 407. The input device 407 is a device used by a user to perform an input operation, such as an operation instruction, for the information processing apparatus 120. The input device 407 is not particularly limited, but for example, can be a mouse and a keyboard. The display device I/F 408 is an interface which can be connected to a display device (display unit) 409. The display device 409 is a device for displaying a variety of information, such as an image and characters. The display device 409 is not particularly limited, but for example, can be a liquid crystal display. The USB I/F 410 is an interface which can be connected to the USB storage 411 via serial communication. With this, it is also possible to store, for example, the image data 900A and the audio data 900B, which are transmitted from the shooting apparatus 110, in the USB storage 411. Further, the information processing apparatus 120 can also be connected to an external apparatus, such as the shooting apparatus 110 and the printing apparatus 130, via the USB I/F 410.

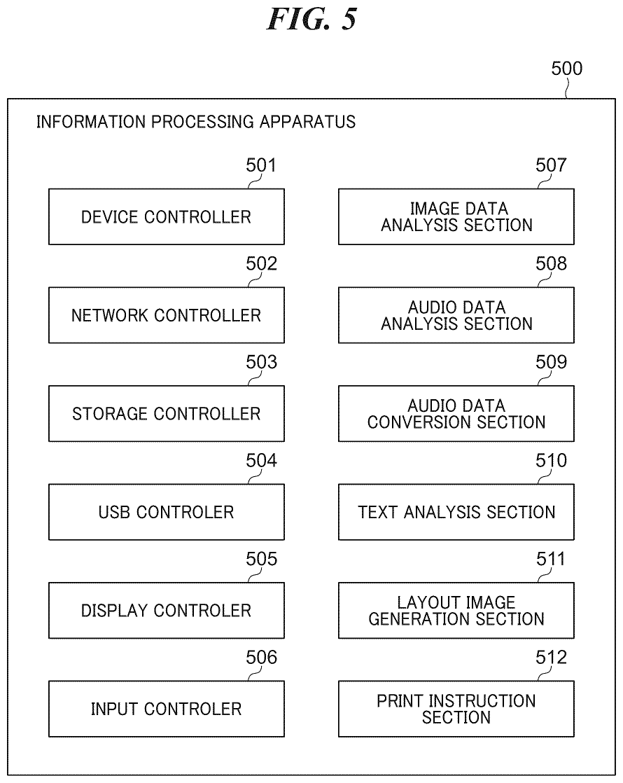

FIG. 5 is a block diagram showing a software configuration of the information processing apparatus. As shown in FIG. 5, the information processing apparatus 120 includes a device controller 501, a network controller (acquisition unit) 502, a storage controller 503, a USB controller 504, a display controller 505, and an input controller 506. Further, the information processing apparatus 120 includes an image data analysis section 507, an audio data analysis section 508, an audio data conversion section (conversion unit) 509, a text analysis section 510, a layout image generation section (generation unit) 511, and a print instruction section 512. These software functions are realized by the CPU 402 that executes programs loaded in the RAM 404. The device controller 501 has a function of controlling the components from the network controller 502 to the print instruction section 512. With this, the overall operation of the information processing apparatus 120 is controlled. The network controller 502 has a function of transmitting and receiving a variety of data to and from an external apparatus by communicating with the network 140 via the network I/F 401. With this, the information processing apparatus 120 can receive and acquire e.g. the image data 900A, the audio data 900B, and the personal information 900C from the shooting apparatus 110. Further, the information processing apparatus 120 can transmit a print job including the layout image 1200 and so forth to the printing apparatus 130. The storage controller 503 has a function of controlling the storage 405 to write and read a variety of data into and from the storage 405. The USB controller 504 has a function of controlling an external device and the USB storage 411, which are connected via the USB I/F 410. The display controller 505 has a function of controlling the display device 409 connected via the display device I/F 408. This makes it possible to display a variety of information on the display device 409. The input controller 506 has a function of controlling the input device 407 connected via the input device I/F 406. This makes it possible to input an operation instruction and so forth via the input device 407.

The image data analysis section 507 has a function of analyzing the image data 900A. In analyzing the image data 900A, for example, machine learning and an image analysis technique are used. Then, as a result of this analysis, for example, person identification data for identifying a predetermined person included in the image data 900A can be obtained. The audio data analysis section 508 has a function of analyzing the audio data 900B. With this, it is possible to identify a speaker based on features of real voices of a plurality of speakers (persons) and divide the audio data 900B on a speaker-by-speaker basis. In analyzing the audio data, for example, a speaker identification technique using deep learning and a sound source separation technique can be used. The audio data conversion section 509 has a function of analyzing the contents of the audio data 900B and converting the audio data 900B to text data. Further, the audio data conversion section 509 can also convert the data items divided on a speaker-by-speaker basis to text data, respectively. In the text conversion, for example, the audio recognition technique using deep learning can be used. The text analysis section 510 has a function of analyzing the contents of text data and dividing text according to context and phrases. In dividing text, for example, a natural language processing technique using deep learning can be used. The layout image generation section 511 has a function of generating a layout image (such as the layout image 1200 and the layout image 1210) in which specific text data included in the text data and the image data 900A are visualized and arranged. The print instruction section 512 has a function of providing a print instruction to the printing apparatus 130 via the network I/F 401. Note that in a case where the printing apparatus 130 is connected to the USB I/F 410, the print instruction section 512 can provide a print instruction to the printing apparatus 130 via the USB I/F 410.

Note that although in the information processing apparatus 120, as the machine learning algorithm, deep learning can be used as described above, this is not limitative, but for example, support vector machine, logistic regression, decision tree, or the like can be used. Further, the information processing apparatus 120 can further have a graphics processing unit (GPU) as the hardware configuration. The GPU is a processor for neural network calculation. In a case where the information processing apparatus 120 further has the GPU, according to a type of processing executed by the information processing apparatus 120, out of the GPU and the CPU 402, the GPU, the CPU 402, or both of the GPU and the CPU 402 operate. Further, in the information processing apparatus 120, e.g. a tensor processing unit (TPU) can be equipped in place of the GPU.

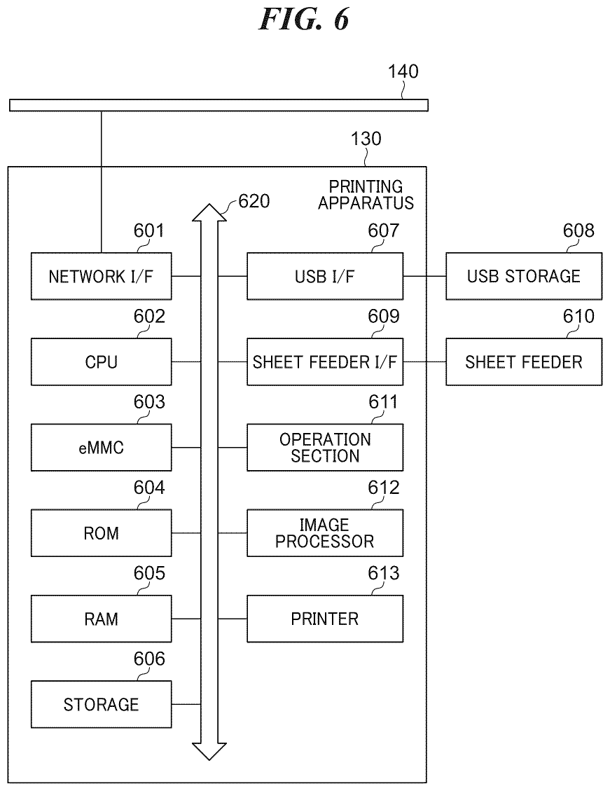

FIG. 6 is a block diagram showing a hardware configuration of the printing apparatus. As shown in FIG. 6, the printing apparatus 130 includes a network I/F 601, a CPU 602, an eMMC 603, a ROM 604, a RAM 605, a storage 606, a USB I/F 607, a sheet feeder I/F 609, an operation section 611, an image processor 612, and a printer 613. The network I/F 601 to the USB I/F 607, the sheet feeder I/F 609, and the operation section 611 to the printer 613 are connected in a state communicable with each other via a system bus 620. The network I/F 601 transmits and receives a variety of data to and from an external apparatus, such as the information processing apparatus 120, via the network 140. The CPU 602 is a controller (computer) for controlling the overall operation of the printing apparatus 130. The CPU 602 starts an OS according to a boot program stored in the ROM 604 which is a nonvolatile memory. Further, the CPU 602 can control the overall operation of the printing apparatus 130 by executing control programs stored in the storage 606, on the OS. The eMMC 603 is implemented by a flash memory and can store the control programs of the CPU 602. The RAM 605 operates as a temporary storage area, such as a main memory and a work area for the CPU 602. The storage 606 is a nonvolatile writable and readable memory, such as an HDD or an SSD, and can store the above-mentioned control programs. The USB I/F 607 is an interface which can be connected to a USB storage 608 via serial communication. With this, it is possible to store print data and so forth in the USB storage 608.

The sheet feeder I/F 609 is an interface which can be connected to a sheet feeder 610. The sheet feeder 610 can feed print sheets required when printing is performed by the printing apparatus 130 to the printer 613 one by one. The operation section 611 is a device for performing an input operation, such as an operation instruction, for the printing apparatus 130. The operation section 611 has an input device, such as a keyboard. Further, the operation section 611 also functions as a display section for displaying a variety of information. In this case, it is preferable that the operation section 611 has a display having a touch panel function. The image processor 612 is a hardware module that performs image processing, such as processing for decoding, enlarging, and reducing print data. The printer 613 is a device for performing printing on a print sheet supplied from the sheet feeder 610, with toner or ink.

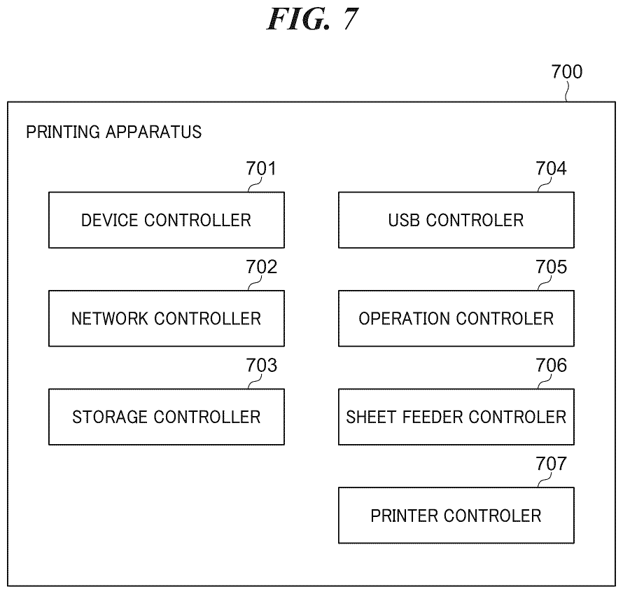

FIG. 7 is a block diagram showing a software configuration of the printing apparatus. As shown in FIG. 7, the printing apparatus 130 includes a device controller 701, a network controller 702, a storage controller 703, a USB controller 704, an operation controller 705, a sheet feeder controller 706, and a printer controller 707. These software functions are realized by the CPU 602 that executes programs loaded in the RAM 605. The device controller 701 has a function of controlling the network controller 702 to the printer controller 707. With this, the overall operation of the printing apparatus 130 is controlled. The network controller 702 has a function of transmitting and receiving a variety of data to and from an external apparatus by communicating with the network 140 via the network I/F 601. With this, the printing apparatus 130 can receive, for example, a print job from the information processing apparatus 120. The storage controller 703 has a function of controlling the storage 606 to write and read a variety of data into and from the storage 606. The USB controller 704 has a function of controlling an external device and the USB storage 608, which are connected via the USB I/F 607. The operation controller 705 has a function of controlling the operation section 611 to acquire input information input from the operation section 611. The sheet feeder controller 706 has a function of controlling the sheet feeder 610 via the sheet feeder I/F 609 to supply a print sheet from the sheet feeder 610. The printer controller 707 has a function of controlling the printer 613 to perform printing by the printer 613.

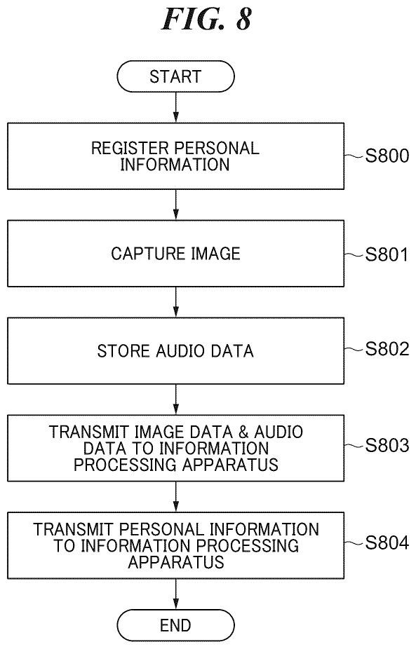

FIG. 8 is a flowchart of a process performed by the shooting apparatus. As shown in FIG. 8, in a step S800, the CPU 202 of the shooting apparatus 110 registers the personal information 900C of a person an image of which is to be captured by the shooting apparatus 110, i.e. a person as an object in the storage 207. The personal information 900C is person identification data for identifying a person. The person identification data is not particularly limited, but for example, at least one of image data of a face of the person and audio data of real voice of the person is included.

In a step S801, the CPU 202 controls the camera 205 to capture an image of the person identified based on the personal information 900C. As a result, the image data 900A is obtained and stored in the storage 207. As described above, the shooting apparatus 110 can automatically detect and track a face of an identified person. With this, the shooting apparatus 110 can continue to automatically capture an image of the identified person by paying attention to the face of the identified persona. Note that the shooting apparatus 110 can also continue to capture an image of the identified person by a user's operation.

In a step S802, if it is determined that the identified person has uttered real voice, the CPU 202 records the audio data 900B including the real voice of the identified person. With this, the audio data 900B is stored in the storage 207. Note that the shooting apparatus 110 can also start recording of the audio data 900B by a user's operation. Further, the step S801 and the step S802 can be executed in reverse order or can be executed at the same time.

In a step S803, the CPU 202 transmits the image data 900A and the audio data 900B, which are stored in the storage 207, to the information processing apparatus 120 via the network I/F 201. With this, the information processing apparatus 120 acquires the image data 900A and the audio data 900B.

In a step S804, the CPU 202 transmits all of the personal information 900C stored in the storage 207 to the information processing apparatus 120 via the network I/F 201, followed by terminating the present process. With this, the information processing apparatus 120 acquires the personal information 900C. Note that the step S803 and the step S804 can be executed in reverse order or can be executed at the same time.

FIG. 9 is a view showing an example of personal information stored in the shooting apparatus. The personal information 900C shown in FIG. 9 is information concerning identification of persons included in the image data 900A, and this information includes, in the present embodiment, a person ID 901, image feature information 902, and audio feature information 90. The person ID 901 is a symbol for identifying a person included in the image data 900A. Although in the present embodiment, alphabets are used as the person ID 901, this is not limitative, but for example, a character or a symbol, or a combination of these can be used. The image feature information 902 is a feature of an image of a person included in the image data 900A. Although a face image of a person is used as the image feature information 902 in the present embodiment, this is not limitative, but for example, a physique of a person can be used. Further, although as a file format of the image feature information 902, JPEG is used in the present embodiment, this is not limitative, but for example, PNG can be used. Further, the image feature information 902 can include a plurality of features per one person. In this case, a file including the plurality of features can be associated with the image feature information 902. The audio feature information 903 is a feature of voice of a person included in the audio data 900B related to the image data 900A. Although real voice data of a person is used as the audio feature information 903 in the present embodiment, this is not limitative. Further, although as a file format of the audio feature information 903, MP3 is used in the present embodiment, this is not limitative, but for example, WAV can be used. Further, the audio feature information 903 can include a plurality of features per one person. In this case, a file including a plurality of features can be associated with the audio feature information 903.

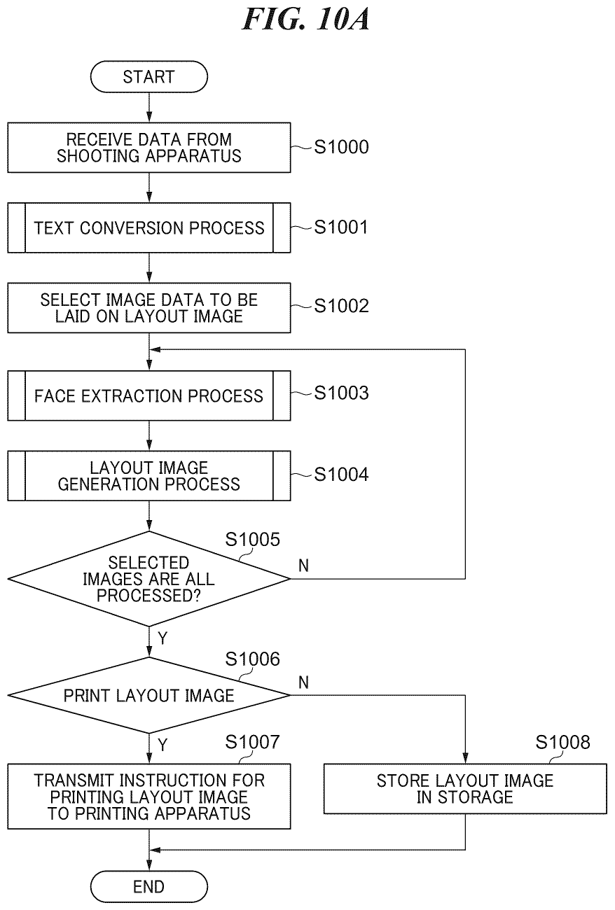

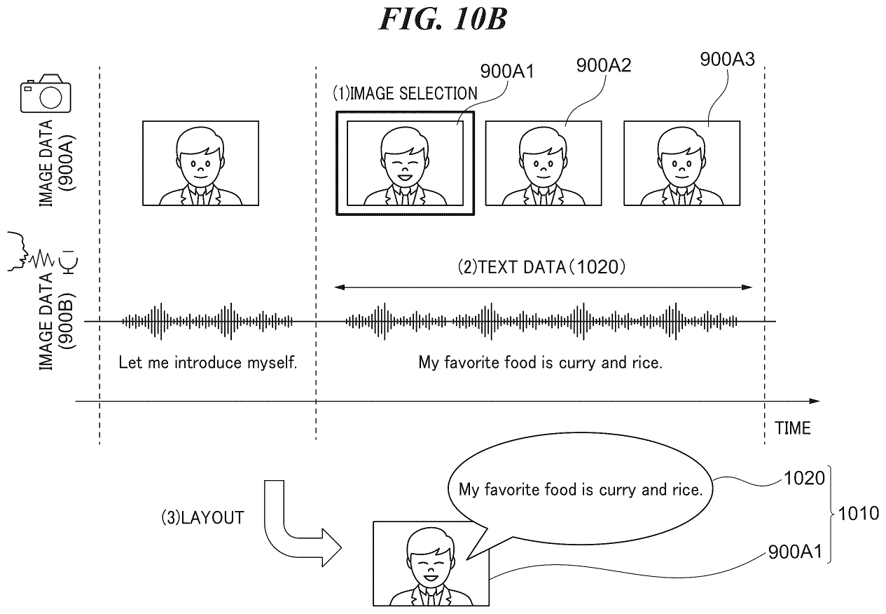

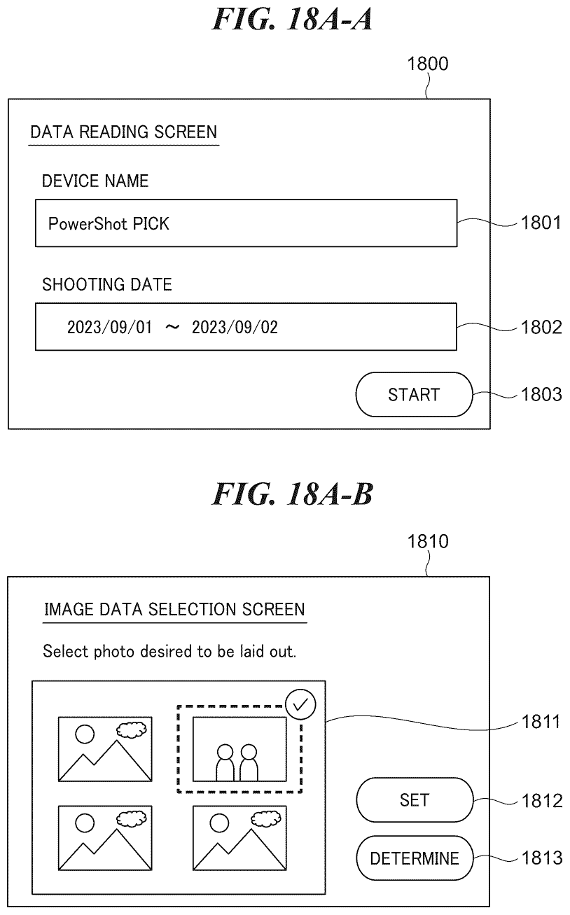

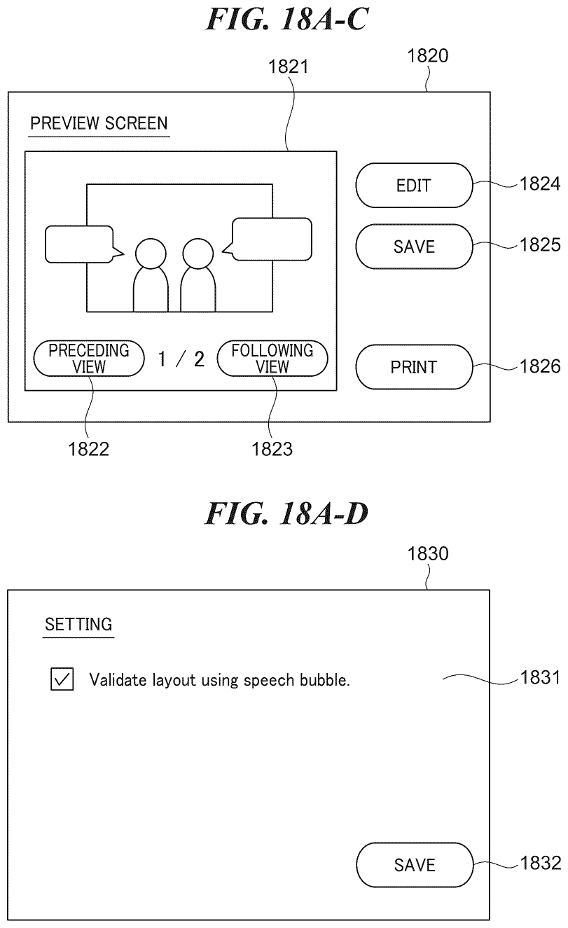

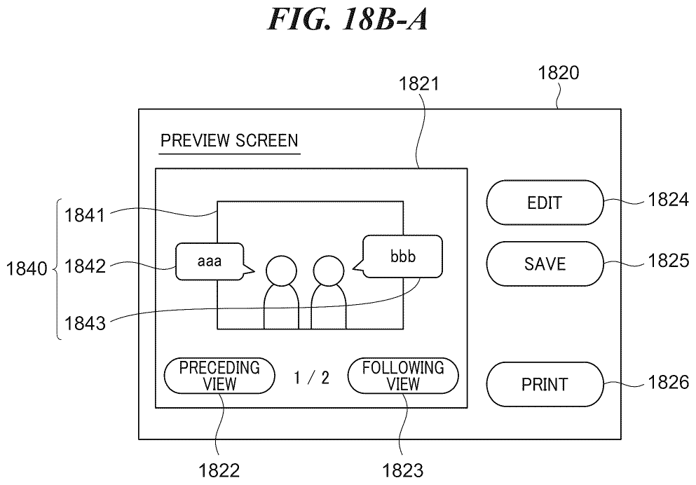

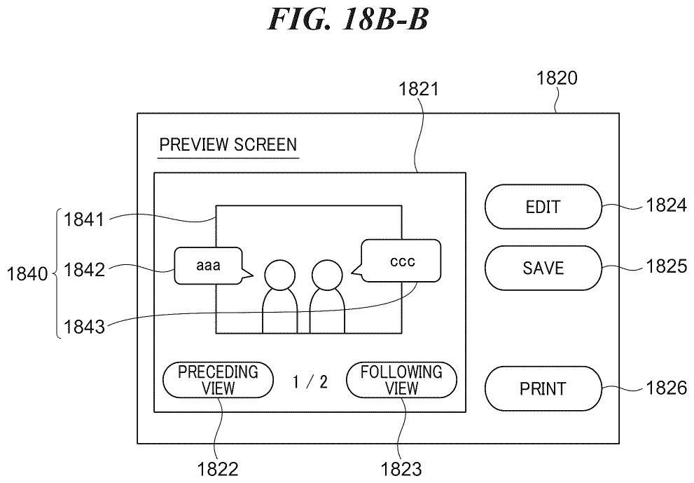

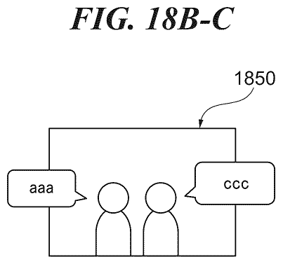

FIG. 10A is a flowchart of a process performed by the information processing apparatus. FIG. 10B is an image diagram illustrating an example of processing performed by the information processing apparatus. As shown in FIG. 10A, in a step S1000, the CPU 402 of the information processing apparatus 120 receives (acquires) a variety of data from the shooting apparatus 110 via the network controller 502. The variety of data includes the image data 900A and the audio data 900B (see FIG. 10B), which have been transmitted in the step S803, and the personal information 900C transmitted in the step S804. The image data 900A, the audio data 900B, and the personal information 900C are stored in the storage 405 of the information processing apparatus 120. Note that in the step S1000, by operating e.g. an operation screen 1800 (see FIG. 18A-A) to designate the shooting apparatus 110 as a data acquisition target and a shooting date, the image data 900A and the audio data 900B satisfying the designation condition can be acquired.

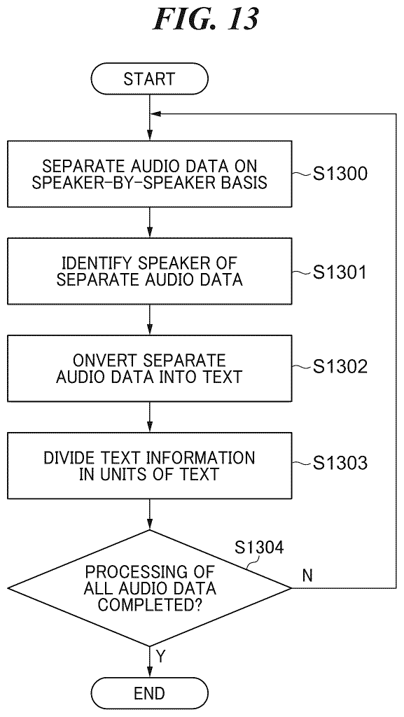

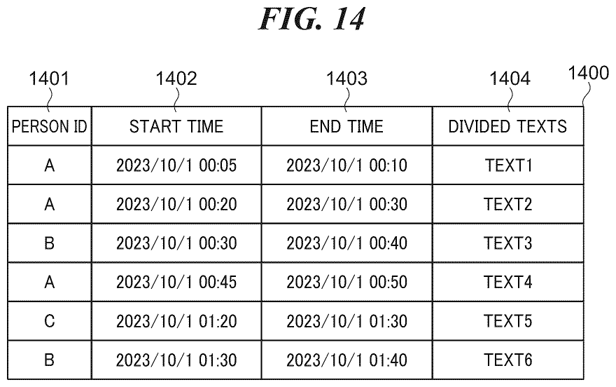

In a step S1001, the CPU 402 controls the audio data analysis section 508 and the audio data conversion section 509 to convert the audio data 900B stored in the storage 405 in the step S1000 to text information (text data) 1400 (see FIG. 14). FIG. 14 is a diagram showing an example of the text information. As shown in FIG. 14, the text information 1400 includes a person ID 1401, a start time 1402, an end time 1403, and a divided text 1404. The person ID 1401 to the divided text 1404 will be described hereinafter with reference to FIG. 14. Further, the detailed process (text conversion process) executed in the step S1001 will be described hereinafter with reference to FIG. 13.

In a step S1002, the CPU 402 selects one image data 900A1 (frame) to be included in a layout image 1010 from within the image data 900A (a plurality of frames) stored in the storage 405 in the step 1000 (see FIG. 10B). This selection is performed, for example, when an operation screen 1810 (see FIG. 18A-B) on which the image data 900A can be confirmed is displayed on the display device 409, and the user selects the desired image data 900A1 on the operation screen 1810 via the input device 407. Thus, in the present embodiment, the operation screen 1810 (input section 407) functions as a selection unit for selecting the image data 900A. Note that one or the plurality of image data 900A1 can be selected on the operation section 1810.

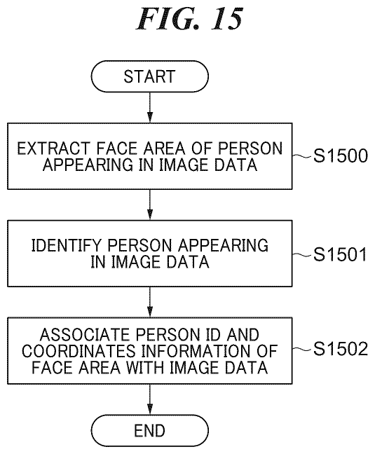

In a step S1003, the CPU 402 controls the image data analysis section 507 to extract a face image (face area) of a person included in the image data 900A1 selected in the step S1002. This extraction is performed by extracting a face image of a person included in the image data 900A1 based on the personal information 900C stored in the storage 405 in the step S1000. Then, specific text information 1020 (see FIG. 10B) generated by converting real voice of the extracted person to text is further extracted from the text information 1400 acquired in the step S1001. Thus, in the present embodiment, the image data analysis section 507 functions as an extraction unit configured to extract the specific text information 1020. Particularly, in a case where the image data 900A is moving image data, the image data analysis section 507 extracts the same person included in image data 900A2 and image data 900A3, which are obtained after the image data 900A1, as the person included in the image data 900A1 selected in the step S1002 (see FIG. 10B). Then, it is preferable to extract a series of text information of real voice uttered by the extracted person from the text information 1400 as the specific text information 1020. This makes it possible to more accurately extract the specific text information 1020 in the case of the moving image data. Note that although the image data 900A2 and the image data 900A3 are the image data obtained after the image data 900A1, depending on the image data 900A1 selected in the step S1002, the same image data is at least one of image data before and after the image data 900A1. The detailed process (face extraction process) executed in the step S1003 will be described hereinafter with reference to FIG. 15.

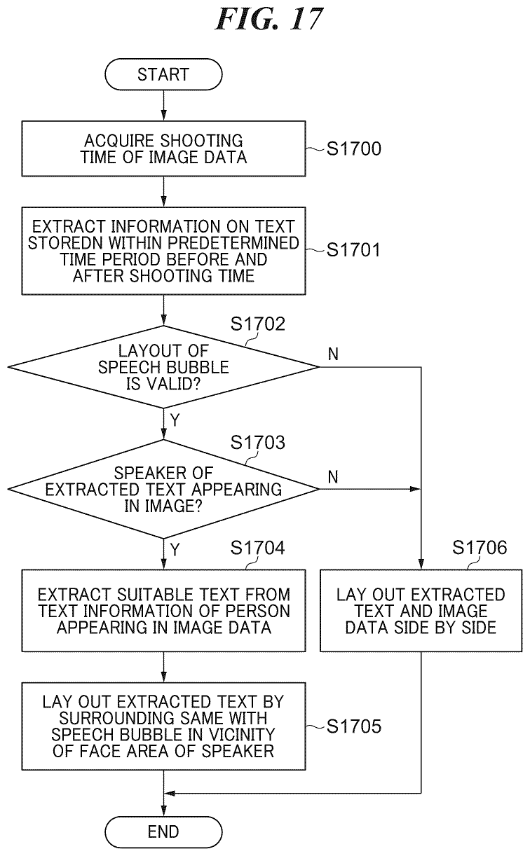

In a step S1004, the CPU 402 controls the layout image generation section 511 to generate the layout image 1010. The layout image 1010 is an image generated by combining and arranging the specific text information 1020 extracted in the step S1003 and the image data 900A1 selected in the step S1002 (see FIG. 10B). The detailed process (layout image generation process) executed in the step S1004 will be described hereinafter with reference to FIG. 17.

In a step S1005, the CPU 402 determines whether or not the layout image generation process has been completed on all of the image data 900A selected in the step S1002. If it is determined in the step S1005 that the layout image generation process has been completed, the process proceeds to a step S1006. On the other hand, if it is determined in the step S1005 that the layout image generation process has not been completed, the process returns to the step S1003, and the step S1003 et seq. are sequentially executed.

In the step S1006, the CPU 402 determines whether or not printing of the layout image 1010 generated in the step S1004 has been instructed. This determination is performed based on, for example, whether or not a print button 1826 has been selected on a preview screen 1820 (see FIG. 18A-C). In a case where the print button 1826 has been selected, the print instruction is provided, whereas in a case where the print button 1826 has not been selected, the print instruction is not provided. Then, if it is determined in the step S1006 that the print instruction has been provided, the process proceeds to a step S1007. On the other hand, if it is determined in the step S1006 that the print instruction has not been provided, the process proceeds to a step S1008.

In the step S1007, the CPU 402 transmits an instruction for printing the layout image 1010 to the printing apparatus 130, followed by terminating the present process. With this, printing of the layout image 1010 is performed by the printing apparatus 130.

In the step S1008, the CPU 402 stores the layout image 1010 in the storage 405, followed by terminating the present process.

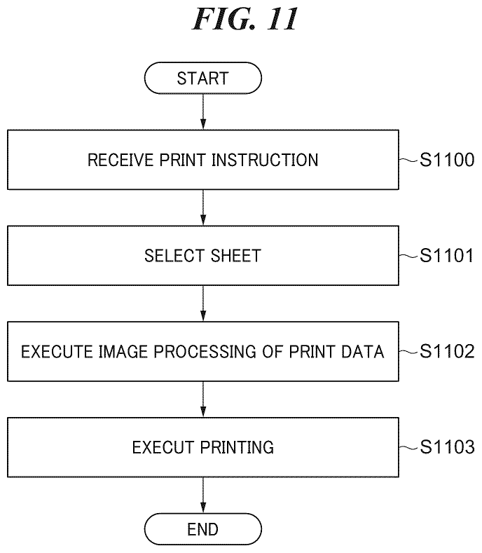

FIG. 11 is a flowchart of a process performed by the printing apparatus. As shown in FIG. 11, in a step S1100, the CPU 602 of the printing apparatus 130 controls the network controller 702 to receive the print instruction from the information processing apparatus 120.

In a step S1101, the CPU 602 selects the sheet feeder 610 based on the print instruction received in the step S1100. In the sheet feeder 610, print sheets of a sheet size designated in the print instruction are accommodated.

In a step S1102, the CPU 602 executes image processing for converting image data to binary image data, for the image data included in the print instruction received in the step S1100.

In a step S1103, the CPU 602 causes the sheet feeder 610 selected in the step S1101 to convey a print sheet to the printer 613 and causes the printer 613 to print the image data subjected to the image processing in the step S1102, followed by terminating the present process. With this, for example, a printed matter on which the layout image 1200 (see FIG. 12A) or the layout image 1210 (see FIG. 12B) has been printed is obtained.

FIGS. 12A and 12B are diagrams each showing an example of the layout image. FIG. 12A shows a first layout image as an example of the layout image. FIG. 12B shows a second layout image as an example of the layout image. The layout image generation section 511 is capable of generating the layout image 1200 shown in FIG. 12A and the layout image 1210 shown in FIG. 12B. As shown in FIG. 12A, in the layout image 1200, an image of the specific text information is disposed in the form of a speech bubble for an image of a person. In the present embodiment, the layout image 1200 includes a person 1201, a person 1202, specific text information 1203, and specific text information 1204. In the vicinity of the face of the person 1201, the specific text information 1203 extracted by the image data analysis section 507 is disposed as the speech bubble of real voice uttered by the person 1201. In the vicinity of the face of the person 1202, the specific text information 1204 extracted by the image data analysis section 507 is disposed as the speech bubble of real voice uttered by the person 1202.

As shown in FIG. 12B, in the layout image 1210, an image of the specific text information is disposed in the form of a column vertically or laterally adjacent to an image of a person. In the present embodiment, the layout image 1210 includes image data 1211 and specific text information 1212. The specific text information 1212 is, for example, itemized text converted from real voice uttered by a person 1213 included in the image data 1211 and is disposed downward adjacent to the image data 1211. Although the specific text information 1212 is disposed downward of the image data 1211 in the configuration illustrated in FIG. 12B, this is not limitative, but for example, the specific text information 1212 can be disposed upward, leftward, or rightward of the image data 1211. Note that the layout image is not limited to the layout image 1200 and the layout image 1210, but for example, an image generated by combining the layout image 1200 and the layout image 1210 can be used.

FIG. 13 is a flowchart of the text conversion process as a subroutine performed in the step 1001 of the process shown in FIG. 10A. As shown in FIG. 13, in a step S1300, the CPU 402 of the information processing apparatus 120 controls the audio data analysis section 508 to separate real voice of all persons included in the audio data 900B, i.e. real voice of all speakers on a speaker-by-speaker basis. Specifically, the audio data analysis section 508 identifies, based on a feature of real voice of each speaker, the speaker by using e.g. the speaker identification technique using deep learning and the sound source separation technique and separates the audio data 900B on a speaker-by-speaker basis. With this, in a case where real voice of a plurality of speakers is included in the audio data 900B, it is possible to extract the audio data 900B of the real voice of a desired speaker, whereby the accuracy in the process after the step S1300 is improved.

In a step S1301, the CPU 402 controls the audio data analysis section 508 to identify the speakers included in the audio data 900B separated in the step S1300. Specifically, the audio data analysis section 508 identifies the speakers included in the audio data 900B based on the person ID 901 and the audio feature information 903 in the personal information 900C by using e.g. the speaker identification technique using deep learning.

In a step S1302, the CPU 402 controls the audio data conversion section 509 to convert the audio data 900B to text for each speaker identified in the step S1301. Specifically, the audio data conversion section 509 converts the audio data 900B to the text information 1400 on a speaker-by-speaker basis by using the audio recognition technique using deep learning, for example. The text information 1400 includes time stamp information at fixed time intervals from the start time of the EXIF information of the audio information 900B. This makes it possible to analyze when words in the text information 1400 have been uttered. After this analysis, processing for associating the person ID 901 associated with the audio data 900B with the converted text information 1400 is performed.

In a step S1303, the CPU 402 controls the text analysis section 510 to divide the text information 1400 of each speaker, which is acquired in the step S1302, in units of text. Specifically, the text analysis section 510 analyzes the contents of the text information 1400 of each speaker, which have been acquired in the step S1302, by using the natural language processing technique using deep learning, for example. Then, the text analysis section 510 divides the text information 1400 into the divided texts 1404 in units of text according to context. Further, in the step S1303, processing for associating the start time 1402 and the end time 1403 of the speech with the divided texts 1404 is executed based on the time stamp information of the text information 1400.

In a step S1304, the CPU 402 determines whether or not the process has been completed for all of the audio data 900B. If it is determined in the step S1304 that the process has been completed for all of the audio data 900B, the process is terminated. On the other hand, if it is determined in the step S1304 that the process has not been completed for all of the audio data 900B, the process returns to the step S1300, and the step S1300 et seq. are sequentially executed.

FIG. 14 is a diagram showing an example of the text information. The text information 1400 shown in FIG. 14 is acquired in the step S1001 of the process in FIG. 10A. The text information 1400 includes the person ID 1401, the start time 1402, the end time 1403, and the divided text 1404, and these are associated with each other. The person ID 1401 is the person ID 901 of the personal information 900C. The start time 1402 is a time at which a person to which each person ID 901 is attached started to utter his/her real voice. The end time 1403 is a time at which a person to which each person ID 901 is attached ended uttering his/her real voice. The start time 1402 and the end time 1403 are generated based on the EXIF information of the audio data 900B received in the step S1000. The divided text 1404 is text information divided in units of text in the step S1303. The format of the divided text 1404 is not particularly limited, but for example, a data format of a character string type, or a file format stored with an extension “.txt” can be used.

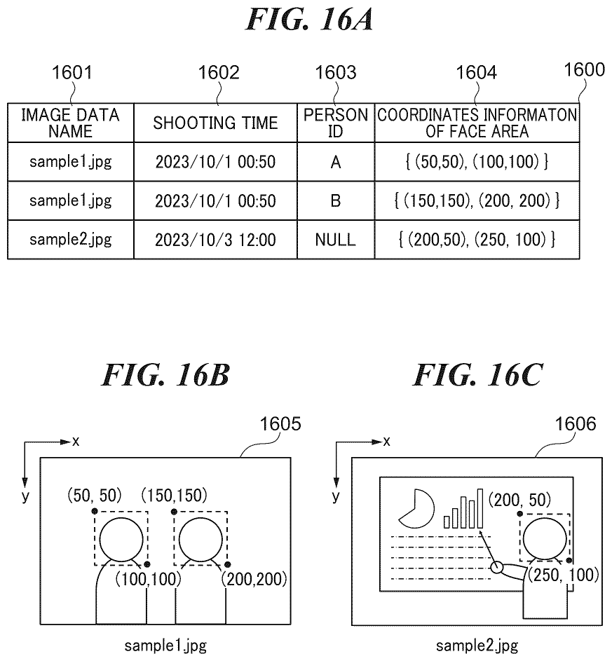

FIG. 15 is a flowchart of the face extraction process as a subroutine performed in the step S1003 of the process shown in FIG. 10A. As shown in FIG. 15, in a step S1500, the CPU 402 of the information processing apparatus 120 controls the image data analysis section 507 to extract a face area of an image of a person included in the image data 900A and acquires coordinates information 1604 (see FIG. 16A) of the extracted face area. Specifically, the image data analysis section 507 extracts a face area of an image of a person included in the image data 900A as a rectangular area by using machine learning and the image analysis technique, for example. Then, the image data analysis section 507 acquires coordinates of two diagonally opposite corners of the rectangular area as the coordinates information 1604 of the face area. Note that the face area of an image of a person is not limited to that acquired by the coordinates information 1604.

In a step S1501, the CPU 402 controls the image data analysis section 507 to identify a person having the coordinates information 1604 acquired in the step S1500. Specifically, the image data analysis section 507 determines whether or not a person to be identified matches a person having the image feature information 902 associated with the person ID 901, by using the image analysis technique in machine learning, for example.

In a step S1502, the CPU 402 associates the coordinates information 1604 with the person identified in the step S1501, followed by terminating the present process.

FIGS. 16A to 16C are diagram each showing an example of face area information. As shown in FIG. 16A, face area information 1600 includes an image data name 1601, a shooting time 1602, a person ID 1603, and the coordinates information 1604. The image data name 1601 is a file name of the image data 900A1 selected in the step S1002 (see FIG. 10A). The shooting time 1602 is a time at which the image data 900A1 to which the image data name 1601 is attached has been shot. The shooting time 1602 is acquired based on the EXIF information of the image data 900A1. The person ID 1603 is a reference numeral for identifying a person identified in the step S1501 (see FIG. 15). For example, as described above, in a case where the person to be identified matches a person having the image feature information 902 associated with the person ID 901, the person ID 901 can be set as the person ID 1603. On the other hand, in a case where the person to be identified does not match a person having the image feature information 902 associated with the person ID 901, NULL can be set as the person ID 1603. The coordinates information 1604 is the coordinates information of the face area acquired in the step S1500 (see FIG. 15). FIG. 16B shows image data 1605 having the image data name 1601 set to sample1.jpg. In the image data 1605, as the coordinates information 1604, (50, 50) and (100, 100) as a pair and (150, 150) and (200, 200) as a pair, are illustrated. FIG. 16C shows image data 1606 having the image data name set to sample2.jpg. In the image data 1606, as the coordinates information 1604, (200, 50) as a pair and (250, 100) as a pair are illustrated.

FIG. 17 is a flowchart of the layout image generation process as a subroutine performed in the step S1004 of the process shown in FIG. 10A. As shown in FIG. 17, in a step S1700, the CPU 402 of the information processing apparatus 120 acquires the shooting time 1602 of the image data 900A which is a target of generation of a layout image, i.e. which is desired to be included in a layout image, from within the face area information 1600.

In a step S1701, the CPU 402 extracts the text information recorded within a predetermined time period before and after the shooting time 1602 acquired in the step S1700. Specifically, the CPU 402 extracts all of the text information 1400 recorded within the predetermined time period (such as one minute) before and after the shooting time 1602 by referring to the start time 1402 and the end time 1403 of the text information 1400. Note that it is preferable that the predetermined time period before and after the shooting time 1602 as the midpoint is appropriately changeable.

In a step S1702, the CPU 402 determines whether or not generation of the first layout image (see FIG. 12A), i.e. generation of a layout image including a speech bubble is valid. Thus, in the present embodiment, the CPU 402 functions as a determination unit configured to determine whether or not generation of the first layout image is valid. Note that in the information processing apparatus 120, part which functions as the determination unit can be arranged separately from the CPU 402. Further, the determination in the step S1702 is performed e.g. based on whether or not a check box 1831 on an operation screen 1830 (see FIG. 18A-D) is checked. In a case where the check box 1831 is checked, it is determined that generation of the first layout image is valid. Further, in a case where the check box 1831 is not checked, it is determined that generation of the first layout image is not valid. If it is determined in the step S1702 that generation of the first layout image is valid, the process proceeds to a step S1703. On the other hand, if it is determined in the step S1702 that generation of the first layout image is not valid, the process proceeds to a step S1706.

In the step S1703, the CPU 402 determines whether or not the speaker of real voice included in the text information extracted in the step S1701 is included, i.e. appears in the image data 900A. Specifically, the CPU 402 determines whether or not data matching the person ID 1603 appearing in the image data 900A to be processed is included in data associated with the person IDs 1401 of the text information 1400 extracted in the step S1701. If it is determined in the step S1703 that the speaker is included in the image data 900A, the process proceeds to a step S1704. On the other hand, if it is determined in the step S1703 that the speaker is not included in the image data 900A, the process proceeds to the step S1706.

In the step S1704, the CPU 402 selects the text information to be included in the first layout image. Specifically, the CPU 402 selects the divided text 1404, based on a selection algorithm, out of the text information having the person ID 1401 of the text information 1400 extracted in the step S1701, which matches the person ID 1603 appearing in the image data to be processed. The selection algorithm refers to, for example, a method of selecting one divided text having the start time 1402 of the conversation, which is closest to the shooting time 1602, or a method of selecting one divided text on an operation screen (not shown) displaying the divided texts 1404 as candidates in the step S1704. Note that in a case where there are a plurality of person IDs 901 matching between the face area information 1600 and the text information 1400 extracted in the step S1701, one or more divided texts 1404 can be selected for each person ID 1603. This makes it possible to display the speech of each person on the first layout image as a speech bubble.

In a step S1705, the CPU 402 arranges the divided text 1404 selected in the step S1704 in the vicinity of the face area of the person on the image data 900A and controls the layout image generation section 511 to generate the first layout image, followed by terminating the present process. Specifically, the layout image generation section 511 generates an object of the divided text 1404 surrounded by a speech bubble. After that, the layout image generation section 511 arranges the object in the vicinity of the face area of the person of the person ID 1603 which is the same as the person ID 1401 of the speaker. As a result, the first layout image is generated.

In the step S1706, the CPU 402 controls the layout image generation section 511 to generate the second layout image (see FIG. 12B) as the layout image, followed by terminating the present process. This second layout image is an image generated by vertically or laterally arranging the text information 1400 extracted in the step S1701 (divided text 1404) and the image data 900A. As for the text information 1400, for example, all text information items 1400 arranged in an order of the start time 1402 from the earliest can be arranged, or the divided texts 1404 associated with the same person ID 1401 can be extracted and arranged in separate arrangement locations on a speaker-by-speaker basis.

As described above, in the information processing apparatus 120, it is determined, before generation of the layout image, which of generation of the first layout image and generation of the second layout image is valid, as the layout image. If it is determined as a result of this determination that generation of the first layout image is valid, the first layout image is generated, whereas if it is determined that generation of the second layout image is valid, the second layout image is generated. Thus, in the information processing apparatus 120, in a case where the image data 900A desired to be included in the layout image is selected, it is possible to acquire the first layout image or the second layout image including the image data 900A and the text information 1400. With this, for example, in a case where the layout image generation system 100 is used in a nursery school or an elementary school, it is possible to select image data desired to be left as a memory as the image data 900. Further, the first layout image (or second layout image) is an image including an image of a kindergartener or a school person, which is included in the image data desired to be left as a memory, and the text information of real voice uttered by the kindergartener or the school person. This first layout image can be included e.g. in a class report or graduation album as one image of memories.

FIGS. 18A-A to 18A-D are diagrams showing an example of operation screens on which operations are performed during generating of the layout image. The operation screen 1800 shown in FIG. 18A-A is a data reading screen operated when the information processing apparatus 120 receives a variety of data from the shooting apparatus 110 and is displayed on the display device 409 by the control performed by the display controller 505. The operation screen 1800 includes a device selection section 1801, a shooting date selection section 1802, and a start button 1803. In the device selection section 1801, it is possible to select a name of the shooting apparatus 110 connected to the information processing apparatus 120 as an acquisition source of the image data 900A. In the shooting date selection section 1802, by setting a time period of shooting, it is possible to designate the image data 900A acquired in this time period. When the start button 1803 is operated, i.e. pressed, it is possible to receive the image data 900A and the audio data 900B of the shooting date, which is designated in the shooting date selection section 1802, from the shooting apparatus 110 selected in the device selection section 1801. After this reception, the operation screen 1800 shifts to an operation screen 1810 shown in FIG. 18A-B.

The operation screen 1810 is an image data selection screen on which image data desired to be included in a layout image can be selected from within the image data items 900A. The operation screen 1810 includes a list display area 1811, a set button 1812, and a determination button 1813. In the list display area 1811, all of the image data items 900A received according to the operation of the start button 1803 on the operation screen 1800 are displayed. The user can select image data desired to be included in the layout image from within all of the image data items 900A e.g. by a click operation using a mouse. After this selection, when the set button 1812 is operated, the operation screen 1810 shifts to an operation screen 1830 shown in FIG. 18A-D. Further, after selection of desired image data, when the determination button 1813 is operated, the layout image generation process is started for the selected image data. After the layout image generation process is terminated, the operation screen shifts to a preview screen 1820 shown in FIG. 18A-C.

The preview screen 1820 includes a preview area 1821, a preceding view button 1822, a following view button 1823, an edit button 1824, a save button 1825, and the print button 1826. In the preview area 1821, a preview image of the layout image acquired by the layout image generation process is displayed. With this, the user can confirm what kind of image is generated as the layout image. Further, in a case where a plurality of layout images are generated, the user can sequentially display the plurality of layout images in the preview area 1821 by operating the preceding view button 1822 or the following view button 1823. By operating the save button 1825, it is possible to save the layout image in the storage 405. Note that in a case where a plurality of layout images are generated, it can be configured such that it is possible to select whether to store only layout image displayed in the preview area 1821 as the preview image or to store all layout images. Further, the layout image can be saved not only by the operation of the save button 1825, but for example, regardless of whether or not the operation of the save button 1825 has been performed, the layout image can be automatically saved when a predetermined time period elapses after the preview screen 1820 is displayed. By operating the print button 1826, it is possible to instruct the printing apparatus 130 to print the layout image. With this, in the printing apparatus 130, printing of the layout image is executed. Note that in a case where a plurality of layout images are generated, it is possible to select whether to print only layout image displayed in the preview area 1821 as the preview image or to print all layout images.

The operation screen 1830 shown in FIG. 18A-D includes the check box 1831 and a save button 1832. As described above, in a case where the check box 1831 is checked, it is determined that generation of the first layout image is valid, whereas in a case where the check box 1831 is not checked, it is determined that generation of the first layout image is not valid. By operating the save button 1832, information on whether or not the check box 1831 is checked is saved in the storage 405.

FIGS. 18B-A to 18B-C are diagrams showing a variation of the operation screens on which operations are performed during generating of the layout image. In the preview area 1821 on the preview screen 1820 shown in FIG. 18B-A, a preview image 1840 of the layout image acquired by the layout image generation process is displayed. The preview image 1840 is an image previewing the first layout image in which an image 1841 of the image data 900A, and a speech bubble 1842 and a speech bubble 1843, as the images of the specific text information 1020, are arranged. In the speech bubble 1842, aaa is described as the contents of the text, and in the speech bubble 1843, bbb is described as the contents of the text. Here, let it be assumed that the user desires to change the contents of the text in the speech bubble 1843 from bbb to ccc. So, the edit button 1824 is operated to make the speech bubble 1843 editable. In this editable state, the user can input ccc by using the input device 407. With this, the preview screen 1820 shifts to a state shown in FIG. 18B-B. Then, as shown in FIG. 18B-C, the layout image generation section 511 can reflect a result of the operation on the input device 407, i.e. a result of inputting ccc by using the input device 407 to a layout image 1850. Further, in the printing apparatus 130, it is possible to obtain a printed matter on which the layout image 1850 has been printed. The editing on the preview area 1821 (preview image) is not limited to the change of the contents of the text included in the speech bubble 1842 or the speech bubble 1843. For example, it is also possible to perform at least one of the editing (operations) of changing of a positional relationship between the image 1841, and the speech bubble 1842 and the speech bubble 1843, and deletion of the speech bubble 1842 and the speech bubble 1843.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-014878 filed Feb. 2, 2024, which is hereby incorporated by reference herein in its entirety.

What is claimed is:

1. An information processing apparatus comprising:
at least one memory and at least one processor which function as:
an acquisition unit configured to acquire image data including an image of a person, and audio data associated with the image data;
a conversion unit configured to convert the audio data acquired by the acquisition unit to text data;
a selection unit configured to select the image data acquired by the acquisition unit; and
a generation unit configured to generate a layout image in which are arranged specific text data of voice uttered by the person included in the image data selected by the selection unit, in the text data, and the image data selected by the selection unit.

2. The information processing apparatus according to claim 1, wherein the acquisition unit is capable of acquiring person identification data for identifying the person, and
wherein the at least one processor further functions as an extraction unit configured to extract the specific text data from within the text data, based on the person identification data acquired by the acquisition unit.

3. The information processing apparatus according to claim 1, wherein the extraction unit extracts a face of the person included in the image data selected by the selection unit from within the text data, based on the person identification data acquired by the acquisition unit, and extracts the specific text data of the person.

4. The information processing apparatus according to claim 2, wherein the generation unit generates, as the layout image, an image in which the specific text data extracted by the extraction unit and the image data selected by the selection unit are arranged.

5. The information processing apparatus according to claim 1, wherein the image data is data of a moving image formed by a plurality of frames, and
wherein the selection unit is capable of selecting one frame of the plurality of frames.

6. The information processing apparatus according to claim 5, wherein the audio data is audio data collectively associated with the plurality of frames, and
wherein the at least one processor further functions as an extraction unit configured to extract, as the specific text data, text data of voice uttered by the person included in one of the one frame selected by the selection unit, and at least one of frames preceding and following the one frame, from within the text data.

7. The information processing apparatus according to claim 1, wherein the image data includes images of a plurality of persons, and
wherein the at least one processor further functions as an extraction unit configured to extract the specific text data of each person.

8. The information processing apparatus according to claim 7, wherein the generation unit generates the layout image in which each specific text data is arranged.

9. The information processing apparatus according to claim 1, wherein the generation unit is capable of generating, as the layout image, a first layout image in which an image of the specific text data is arranged in the form of a speech bubble for an image of the person, and a second layout image in which the image of the specific text data is arranged in the form of a column vertically or laterally adjacent to the image of the person.

10. The information processing apparatus according to claim 9, wherein the at least one processor further functions as a determination unit configured to determine, before generation of the layout image by the generation unit, which of generation of the first layout image and generation of the second layout image is valid as the layout image, and
wherein the generation unit executes the generation of the first layout image, in a case where it is determined, as a result of determination by the determination unit, that the generation of the first layout image is valid, and executes the generation of the second layout image, in a case where it is determined, as the result of determination by the determination unit, that the generation of the second layout image is valid.

11. The information processing apparatus according to claim 1, wherein the image data includes a plurality of persons,
wherein the audio data includes data of real voice of each person, and
wherein the conversion unit separates the audio data into data items of real voice of the persons, respectively, and converts each data item to the text data.

12. The information processing apparatus according to claim 2, wherein the information processing apparatus is communicably connected to an image capturing apparatus capable of storing the image data, the audio data, and the person identification data, and
wherein the acquisition unit acquires the image data, the audio data, and the person identification data from the image capturing apparatus.

13. The information processing apparatus according to claim 1, wherein the at least one processor further functions as:
a display unit capable of displaying a preview image of the layout image, and
an operation unit configured to be capable of performing, on the preview screen, at least one of changing a positional relationship between an image of the image data and an image of the specific text data, deletion of the image of the specific text data, and changing contents of text included in the image of the specific text data.

14. The information processing apparatus according to claim 13, wherein the generation unit reflects a result of the operation by the operation unit on the layout image.

15. A method of controlling an information processing apparatus, comprising:
acquiring image data including an image of a person, and audio data associated with the image data;
converting the audio data acquired by the acquiring to text data;
selecting the image data acquired by the acquiring; and
generating a layout image in which are arranged specific text data of voice uttered by the person included in the image data selected by the selecting, in the text data, and the image data selected by the selecting.

16. A non-transitory computer-readable storage medium storing a program for causing a computer to execute a method of controlling an information processing apparatus,
wherein the method comprises:
acquiring image data including an image of a person, and audio data associated with the image data;
converting the audio data acquired by the acquiring to text data;
selecting the image data acquired by the acquiring; and
generating a layout image in which are arranged specific text data of voice uttered by the person included in the image data selected by the selecting, in the text data, and the image data selected by the selecting.
